(19) United States
(12) Patent Application Publication
(10) Pub. No.: US 2004/0145556 A1
(43) Pub. Date: Jul. 29, 2004

(54) Electro-optical device, method of driving electro-optical device, and electronic apparatus

(75) Inventor: Hayato Nakanishi, Toyama-shi (JP)

Correspondence Address: OLIFF & BERRIDGE, PLC, P.O. BOX 19928, ALEXANDRIA, VA, 22320, US

(73) Assignee: SEIKO EPSON CORPORATION, TOKYO (JP)

(21) Appl. No.: 10/693,958

(22) Filed: Oct. 28, 2003

(30) Foreign Application Priority Data
Oct. 28, 2002 (JP) 2002-312795

(51) Int. Cl. G09G 3/36; G09G 5/00

(52) U.S. Cl. 345/99; 345/204

(57) ABSTRACT

To provide an electro-optical device capable of testing whether a sufficient amount of data has been written in precharged data lines, with a simple structure and a high degree of precision, a test switch for red STR is connected between a test line for red TLR and a data line for red DLR. A test switch for green STG is connected between a test line for green TLG and a data line for green DLG. A test switch for blue STB is connected between a test line for blue TLB and a data line for blue DLB. When the test switches STR, STG, and STB are switched on based on control signals SGx1 to SGx3, voltages of the data lines DLR, DLG, and DLB based on data voltages VRdata, VGdata, and VBdata supplied to the data lines DLR, DLG, and DLB are respectively output to the test lines for red, green, and blue TLR, TLG, and TLB as detection signals Vmr, Vmg, and Vmb.

### BACKGROUND OF THE INVENTION

1. Field of Invention

The present invention relates to an electro-optical device, a method of driving the electro-optical device, and an electronic apparatus.

2. Description of Related Art

In related art electro-optical devices, for example, organic electroluminescent (EL) display devices, an active matrix driving method (hereinafter, referred to as an active method) is used as a method of emitting light by appropriately selecting organic EL elements provided in positions corresponding to the intersections of scanning lines and data lines formed on a substrate. According to the active method, in general, scanning lines select the pixel circuits of the EL elements that emit light and supply data values (data for determining the values of the currents that flow through the organic EL elements) for determining the gray scale of the organic EL elements to the selected pixel circuits through the data lines.

However, in such display devices, because parasitic capacitance applied to the data lines is large, insufficient data is written in the data lines. The data lines are different from the scanning lines and are formed so that cathode wiring lines above and near the data lines intersect the data lines. As a result, the parasitic capacitance of the data lines is larger than that of the scanning lines.

Thus, a precharge circuit is used in order to prevent predetermined data from not being supplied to the pixel circuits within a predetermined time due to the insufficient amount of data written in the data lines (for example, refer to Japanese Unexamined Patent Application Publication No. 2002-175045). Specifically, charges are supplied from a precharge circuit to the respective data lines so as to raise the data lines to an intermediate level at the stage prior to writing data in pixel circuits. Thereby, when data is written in the pixel circuits through the data lines, because the data lines are precharged to the intermediate level, the time it takes to reach a target data value is shortened. Therefore, the precharge circuit is indispensable for controlling such display devices with a high degree of precision.

It is not possible to manufacture pixel circuits and EL elements with the same degree of precision due to a difference in the manufacturing processes of pixel circuits and EL elements on a substrate. Therefore, it is necessary to perform various tests before shipping products.

However, a simple visual inspection, to determine the omission of dots is, for example, performed in the tests. An electric test is limited to simply testing shorts or disconnections of a source voltage.

Therefore, it is necessary to test whether data has been written suitably so that the organic EL elements operate in a desired state with a high degree of precision. In particular, it is practical but very difficult to write data after precharging the data lines, due to the parasitic capacitance of the data lines and to quantitatively test whether insufficient data has been written, and thus, it is not performed actually. Therefore, it is necessary to perform the quantitative test in order to achieve high-quality display.

### SUMMARY OF THE INVENTION

The present invention has been made to address the above problems. The present invention provides an electro-optical device, a method of driving the electro-optical device, and an electronic apparatus, which make it possible to test whether a sufficient amount of data has been written in precharged data lines with a simple structure and a high degree of precision.

An electro-optical device in an aspect of the present invention includes: a plurality of scanning lines; a plurality of data lines; a plurality of electro-optical elements provided to correspond to intersections of the plurality of scanning lines and the plurality of data lines; first switches to control the supply of a precharge signal from a precharge signal supply line connected to at least one data line of the plurality of data lines to the at least one data line; second switches connected to the at least one data line of the plurality of data lines to control the output of a detection signal from the at least one data line to test lines; and a data line selection circuit to set the on or off state of the second switches.

According to the above electro-optical device, the data line selection circuit makes it possible to output the detection signals from the data lines to the test lines by operating the second switches provided in the data lines. As a result, it is possible to test whether a sufficient amount of data has been written in the precharged data lines with a simple structure and a high degree of precision.

An electro-optical device in an aspect of the present invention includes: a plurality of scanning lines; a plurality of data lines; a plurality of electro-optical elements provided to correspond to intersections of the plurality of scanning lines and the plurality of data lines; third switches to control the supply of precharge signals from input and output signal lines connected to at least one data line of the plurality of data lines to the at least one data line and to control the output of a test signal from the at least one data line to the input and output signal lines; and a data line selection circuit to set the on or off state of the third switches.

According to the above electro-optical device, the data line selection circuit makes it possible to output the detection signals from the data lines to the input and output signal lines by operating the third switches provided in the data lines. As a result, it is possible to test whether a sufficient amount of data has been written in the precharged data lines with a simple structure and a high degree of precision. Furthermore, it is possible to miniaturize the circuits.

An electro-optical device in an aspect of the present invention includes: a plurality of scanning lines; a plurality of data lines; a plurality of electro-optical elements provided to correspond to intersections of the plurality of scanning lines and the plurality of data lines; at least two precharge lines to supply precharge signals to at least two data lines of the plurality of data lines; first switches to control the output of the precharge signals from the at least two precharge lines to the at least two data lines; and second switches to control the output of detection signals from the at least two data lines of the plurality of data lines to test lines.

According to the above electro-optical device, the precharge signals are supplied to at least two data lines among the plurality of data lines by the first switches. Further, the second switches make it possible output the precharge signals from the at least two data lines as the detection signals from the two precharge lines to the test lines. As a result, it is possible to supply optimal precharge signals to at least two data lines and to output the precharge results thereto.

In the above electro-optical device, a data line selection circuit to control precharge signals output from the at least two data lines to the test lines by sequentially operating the second switches is provided.

According to the above electro-optical device, the data line selection circuit makes it possible to sequentially output the detection signals from the data lines by sequentially operating the second switches. As a result, it is possible to test whether a sufficient amount of data has been written in the data lines to which the precharge signals have been precharged with a high degree of precision.

A method of driving an electro-optical device in an aspect of the present invention includes: a plurality of scanning lines; a plurality of data lines wired to intersect the scanning lines; electronic circuits provided to correspond to intersections of the scanning lines and the data lines; first switches to control the supply of a precharge signal from a precharge signal supply line connected to at least one data line of the plurality of data lines to the at least one data line; and second switches connected to the at least one data line of the plurality of data lines to control the output of a detection signal from the at least one data line to test lines, the method including: a first step of supplying a precharge signal from a precharge signal supply line to the data lines through the first switches when one of the plurality of scanning lines is selected; a second step of supplying data signals to electronic circuits connected to the selected scanning line through the data lines; and a third step of outputting data signals supplied to the data lines as detection signals to test lines through the second switches.

According to the method of driving an electro-optical device, it is possible to output the detection signals from the data lines to the test lines by operating the second switches provided in the data lines. As a result, it is possible to test whether a sufficient amount of data has been written in the precharged data lines with a simple structure and a high degree of precision.

A method of driving an electro-optical device in an aspect of the present invention includes: a plurality of scanning lines; a plurality of data lines wired to intersect the scanning lines; electronic circuits provided to correspond to intersections of the scanning lines and the data lines; at least two precharge lines to supply precharge signals to at least two data lines of the plurality of data lines; first switches to control the output of the precharge signals from the at least two precharge lines to the at least two data lines; and second switches to control the output of detection signals from the at least two data lines of the plurality of data lines to test lines, the method including: a first step of supplying a precharge signal from a precharge signal supply line to the data lines through the first switches when one of the plurality of scanning lines is selected; a second step of supplying data signals to electronic circuits connected to the selected scanning line through the data lines; and a third step of outputting data signals supplied to the data lines as detection signals to the test lines through the second switches.

According to the method of driving an electro-optical device, it is possible to sequentially output the detection signals from the data lines to the test lines by sequentially operating the second switches. As a result, it is possible to test whether a sufficient amount of data has been written in the data lines to which the precharge signals have been precharged for each electronic circuit with a high degree of precision.

According to the above electronic apparatus, it is possible to test whether a sufficient amount of data has been written in the data lines to which the precharge signals have been precharged with a high degree of precision.

### BRIEF DESCRIPTION OF THE DRAWINGS

FIG. 1 is a circuitry block schematic illustrating a circuit structure of an organic EL display according to a first exemplary embodiment;

FIG. 2 is a circuit schematic illustrating internal circuit structures of a display panel and a test circuit according to a first exemplary embodiment;

FIG. 3 is a circuit schematic illustrating internal circuit structures of a pixel circuit and a precharge circuit according to a first exemplary embodiment;

FIG. 4 is a circuit schematic illustrating internal circuit structures of a display panel and a test and precharge circuit according to a second exemplary embodiment;

FIG. 5 is a circuit schematic illustrating structures of a test and precharge circuit and a gate circuit according to a second exemplary embodiment;

FIG. 6 is a circuit schematic illustrating internal circuit structures of a pixel circuit and a precharge circuit according to a third exemplary embodiment;

FIG. 7 is a perspective view illustrating a structure of a mobile personal computer according to a fourth exemplary embodiment;

FIG. 8 is a perspective view illustrating a structure of a mobile telephone according to the fourth exemplary embodiment.

### DETAILED DESCRIPTION OF PREFERRED EMBODIMENTS

First Exemplary Embodiment

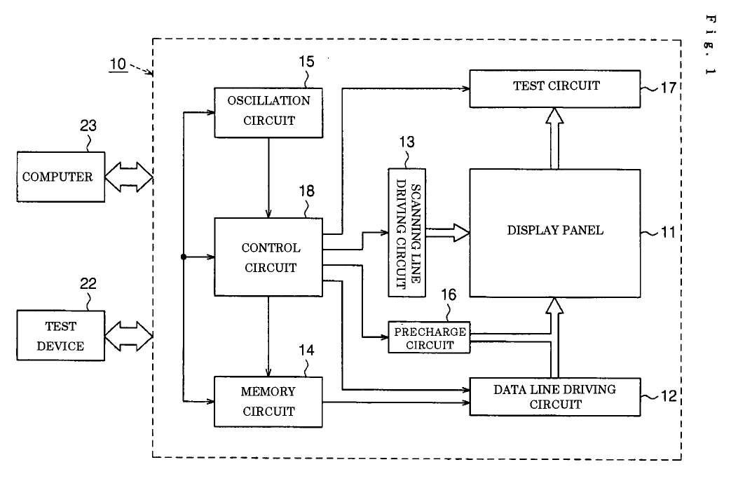

A first exemplary embodiment of the present invention will now be described with reference to FIGS. 1 to 5.

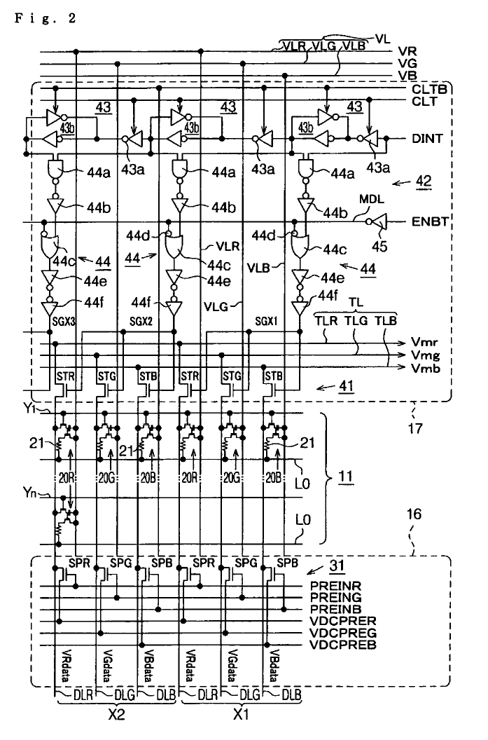

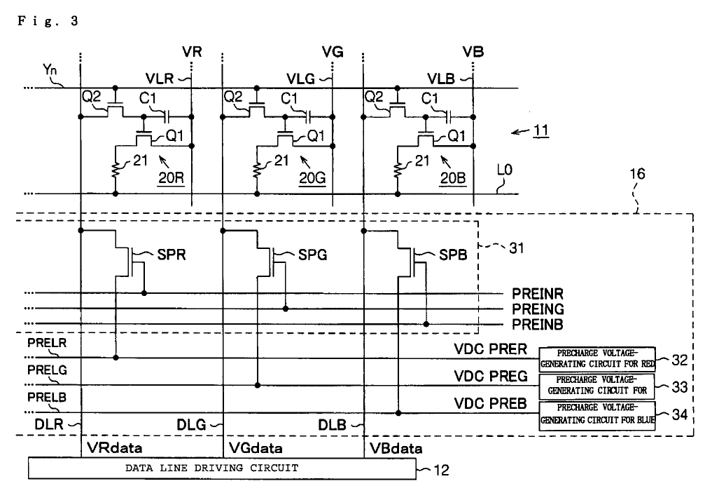

FIG. 1 is a circuitry block schematic illustrating a circuit structure of an organic EL display 10 as an electro-optical device. FIG. 2 is a circuit schematic illustrating internal circuit structures of a display panel and a test circuit. FIG. 3 is a circuit schematic illustrating internal circuit structures of a pixel circuit and a precharge circuit.

In FIG. 1, the organic EL display 10 includes a display panel 11, a data line driving circuit 12, a scanning line driving circuit 13, a memory circuit 14, an oscillation circuit 15, a precharge circuit 16, a test circuit 17, and a control circuit 18 as a data line selection circuit.

The display panel 11 and the circuits 12 to 18 of the organic EL display 10 may include independent electronic parts, respectively. For example, the circuits 12 to 18 may include one-chip semiconductor integrated circuit devices, respectively. Further, all or some of the display panel 11 and the circuits 12 to 18 may be integrally configured as an electronic part. For example, the data line driving circuit 12 and the scanning line driving circuit 13 may be integrated in the display panel 11. All or some of the circuits 12 to 17 may be configured by a programmable IC chip. Therefore, the functions thereof may be realized by software, such as programs written in the IC chips.

The display panel 11 has pixel circuits for red, green, and blue 20R, 20G, and 20B as a plurality of electronic circuits arranged in a matrix as illustrated in FIG. 2. That is, a group of pixel circuits for red, green, and blue 20R, 20G, and 20B as a pixel are connected between a plurality of data lines X1 to Xm (m is an integer) extending along the column direction thereof and a plurality of scanning lines Y1 to Yn (n is an integer) extending along the row direction thereof. Therefore, groups of pixel circuits for red, green, and blue 20R, 20G, and 20B are arranged in a matrix.

Each of the pixel circuits for red, green, and blue 20R, 20G, and 20B has an organic EL element 21 as an electro-optical element with a light-emitting layer made of an organic material. Specifically, the pixel circuit for red 20R has an organic EL element 21 that emits red light. The pixel circuit for green 20G has organic EL element 21 that emits green light. The pixel circuit for blue 20B has an organic EL element 21 that emits blue light. Generally, a later-mentioned transistor formed in each of the pixel circuits 20R, 20G, and 20B includes a thin film transistor (TFT).

As illustrated in FIG. 3, each of the pixel circuits 20R, 20G, and 20B includes a driving transistor Q1, a programmable transistor Q2, and a storage capacitor C1 as a capacitive element. An N channel field effect transistor (FET) includes the driving transistor Q1 and the programmable transistor Q2.

A source of the driving transistor Q1 is connected to an anode of the organic EL element 21 and a drain thereof is connected to a driving power line VL. The storage capacitor C1 is connected between a gate of the driving transistor Q1 and the driving power line VL.

In the present exemplary embodiment, the driving power line VL includes a driving power line for red VLR, a driving power line for green VLG, and a driving power line for blue VLB. The driving transistor Q1 of the pixel circuit for red 20R is connected to the driving power line for red VLR. Therefore, a source voltage VR is applied to the driving transistor Q1 of the pixel circuit for red 20R. The driving transistor Q1 of the pixel circuit for green 20G is connected to the driving power line for green VLG. Therefore, a source voltage VG is applied to the driving transistor Q1 of the pixel circuit for green 20G. The driving transistor Q1 of the pixel circuit for blue 20B is connected to the driving power line for blue VLB. Therefore, a source voltage VB is applied to the driving transistor Q1 of the pixel circuit for blue 20B.

This is because the characteristics of the organic EL elements 21 that emit red, green, and blue light are different from each other. Therefore, when light is emitted from the organic EL elements 21 that emit red, green, and blue light, the source voltages VR, VG, and VB supplied to the driving transistor Q1 of the pixel circuits for red, green, and blue 20R, 20G, and 20B are made different from each other in accordance with the organic EL elements 21. Further, cathodes of the organic EL elements 21 are connected to a cathode line L0.

Gates of the programmable transistors Q2 of the pixel circuits 20R, 20G, and 20B are connected to the corresponding scanning lines Y1 to Yn, respectively. Moreover, drains of the programmable transistors Q2 are connected to the data lines X1 to Xm and a source thereof are connected to the gates of the driving transistors Q1 and the storage capacitors C1. The data lines X1 to Xm include data lines for red DLR, data lines for green DLG, and data lines for blue DLB. Therefore, the programmable transistor Q2 of the pixel circuit for red 20R is connected to the data line for red DLR. The programmable transistor Q2 of the pixel circuit for green 20G is connected to the data line for green DLG.

Furthermore, the programmable transistor Q2 of the pixel circuit for blue 20B is connected to the data line for blue DLB.

A data signal for red (a data voltage VRdata) is output from the data line driving circuit 12 to the pixel circuit for red 20R through the data line for red DLR. A data signal for green (a data voltage VGdata) is output from the data line driving circuit 12 to the pixel circuit for green 20G through the data line for green DLG. A data signal for blue (a data voltage VBdata) is output from the data line driving circuit 12 to the pixel circuit for blue 20B through the data line for blue DLB.

The data line driving circuit 12 receives video signals from the control circuit 18 and sequentially supplies electric signals (the data signals (the data voltages VRdata, VGdata, and VBdata)) corresponding to brightness gray scale to the pixel circuits 20R, 20G, and 20B on one selected scanning line through the data lines X1 to Xm.

That is, in the present exemplary embodiment, the data voltages VRdata, VGdata, and VBdata are sequentially supplied to a pixel including a group of pixel circuits for red, green, and blue 20R, 20G, and 20B connected in the row direction, that is, on a selected scanning line in the column direction.

For example, when six brightness gray scale levels exist, six levels of data voltages VRdata, VGdata, and VBdata are generated. A group of data voltages VRdata, VGdata, and VBdata in accordance with each gray scale is output from the data line driving circuit 12 to each group of pixel circuits 20R, 20G, and 20B. Internal states of the pixel circuits 20R, 20G, and 20B are set in accordance with the data voltages VRdata, VGdata, and VBdata. The values of the currents that flow through the organic EL elements 21 of the pixel circuits 20R, 20G, and 20B are controlled in accordance with the internal states, thereby controlling the brightness gray scale of the organic EL elements 21.

The data line driving circuit 12 makes the ranges of the data voltages VRdata, VGdata, and VBdata output in accordance with the gray scale level to the pixel circuits for red, green, and blue 20R, 20G, and 20B different from each other. As mentioned above, this is because the characteristics of the organic EL elements 21 that emit red, green, and blue light are different from each other. Therefore, when light is emitted from the organic EL elements 21 that emit red, green, and blue light with the same gray scale levels, the data voltages VRdata, VGdata, and VBdata output from the data line driving circuit 12 are different from each other in the pixel circuits 20R, 20G, and 20B. Therefore, the voltage levels of the data voltages VRdata, VGdata, and VBdata in the respective gray scale levels between the maximum values and 0 volts are different from each other.

The scanning line driving circuit 13 selectively drives only one among the plurality of scanning lines Yn, thereby selecting a group of a row of pixel circuits. The memory circuit 14 stores image data supplied from a computer 23. Further, the memory circuit 14 stores image data for test supplied from a test device 22. The oscillation circuit 15 supplies a reference actuating signal to the other circuits of the organic EL display 10.

The precharge circuit 16 provided between the display panel 11 and the data line driving circuit 12 includes a first gate circuit 31, a precharge voltage-generating circuit for red 32, a precharge voltage-generating circuit for green 33, and a precharge voltage-generating circuit for blue 34.

The first gate circuit 31 include of analog switches SPR, SPG, and SPB having N channel FETs connected to the data lines for red, green, and blue DLR, DLG, and DLB of each of the data lines X1 to Xm. A drain of the analog switch for red SPR connected to the data line for red DLR is connected to the precharge voltage-generating circuit for red 32 through a precharge power line for red PRELR as a precharge supply line. Further, a drain of the analog switch for green SPG connected to the data line for green DLG is connected to the precharge voltage-generating circuit for green 33 through a precharge power line for green PRELG as a precharge supply line. Moreover, a drain of the analog switch for blue SPB connected to the data line for blue DLB is connected to the precharge voltage-generating circuit for blue 34 through a precharge power line for blue PRELB as a precharge supply line.

Furthermore, in the present exemplary embodiment, the analog switches SPR, SPG, and SPB constitute a first switch in the claims.

The precharge voltage-generating circuit for red 32 supplies a precharge voltage VDCPRER to the data line for red DLR. In the present exemplary embodiment, the voltage value that is half of the maximum value of the data voltage VRdata output from the data line driving circuit 12 to the pixel circuit for red 20R is output as the precharge voltage VDCPRER. Further, the precharge voltage-generating circuit for green 33 supplies a precharge voltage VDPREG to the data line for green DLG.

In the present exemplary embodiment, the voltage value that is half of the maximum value of the data voltage VGdata output from the data line driving circuit 12 to the pixel circuit for green 20G is output as a precharge voltage VDCPREG. Moreover, the precharge voltage-generating circuit for blue 34 supplies a precharge voltage VDCPREB to the data line for blue DLB. In the present exemplary embodiment, the voltage value that is half of the maximum value of the data voltage VBdata output from the data line driving circuit 12 to the pixel circuit for blue 20B is output as a precharge voltage VDCPREB. Therefore, the precharge voltages VDCPRER, VDCPREG, and VDCPREB output from the precharge voltage-generating circuits 32 to 34 are different from each other.

Precharge control signals PREINR, PREING, and PREINB are input from the control circuit 18 to the gates of the analog switches SPR, SPG, and SPB. The analog switches SPR, SPG, and SPB are switched on in response to the precharge control signals PREINR, PREING, and PREINB. The precharge voltages VDCPRER, VDCPREG, and VDCPREB are supplied from the precharge voltage-generating circuits 32 to 34 to the corresponding data lines X1 to Xm (the data lines for red, green, and blue DLR, DLG, and DLB) based on the on state of the analog switches SPR, SPG, and SPB.

As illustrated in FIG. 2, the test circuit 17 includes a test line TL and a second gate circuit 41 and the test line TL is connected to the data lines X1 to Xm through the second gate circuit 41. The test line TL includes a test line for red TLR, a test line for green TLG, and a test line for blue TLB. The test line for red TLR is connected to the data line for red DLR through the second gate circuit 41. The test line for green TLG is connected to the data line for green DLG through the second gate circuit 41. The test line for blue TLB is connected to the data line for blue DLB through the second gate circuit 41.

The second gate circuit 41 is provided opposite to the first gate circuit 31 while interposing the data lines X1 to Xm. The second gate circuit 41 includes the analog switches (hereinafter, referred to as test switches) STR, STG, and STB including N channel FETs respectively connected to the data lines for red, green, and blue DLR, DLG, and DLB of the data lines X1 to Xm. That is, in the present exemplary embodiment, a group of test switches STR, STG, and STB is provided in each group of pixel circuits for red, green, and blue 20R, 20G, and 20B connected in the row direction, that is, on the selected scanning line. Further, in the present exemplary embodiment, the analog switches (test switches) STR, STG, and STB constitutes a second switch in the claims.

Sources of the test switches for red STR are connected to the test line for red TLR, and drains thereof are connected to the corresponding data lines for red DLR. Sources of the test switches for green STG are connected to the test line for green TLG, and drains thereof are connected to the corresponding data lines for green DLG. Sources of the test switches for blue STB are connected to the test line for blue TLB, and drains thereof are connected to the corresponding data lines for blue DLB.

Each group of test switches STR, STG, and STB of each of the data lines X1 to Xm is switched on based on control signals SGx1 to SGxm input to the gates thereof. When each group of test switches STR, STG, and STB is switched on in the present exemplary embodiment, the voltages applied to the data lines DLR, DLG, and DLB are output to the test line for red TLR, the test line for green TLG, and the test line for blue TLB, respectively. Specifically, the voltages applied to the data lines DLR, DLG, and DLB based on the data voltages VRdata, VGdata, and VBdata supplied to the data lines DLR, DLG, and DLB are respectively output to the test line for red TLR, the test line for green TLG, and the test line for blue TLB as detection signals Vmr, Vmg, and Vmb.

The test circuit 17 includes a signal-generating circuit 42 to generate the control signals SGx1 to SGxm. The signal-generating circuit 42 includes a shift register obtained by serially connecting latch circuits 43, each having an input portion 43a including a clocked inverter, and a latch portion 43b including two clocked inverters, to each other by the number of data lines X1 to Xm. The signal-generating circuit 42 sequentially shifts a high potential (an H level) of one-pulse test signal DINT input from an initial stage of latch circuit 43 to a next stage of latch circuit 43 in response to first and second clock signals for test CLT and CLTB including complementary signals.

Further, the one-pulse test signal DINT is generated by the control circuit 18 and is output in the test mode of testing the pixel circuits 20R, 20G, and 20B using the test device 22 at a predetermined timing. The test signal DINT is not output during normal operation (in the normal mode). Moreover, the first and second clock signals for test CLT and CLTB are generated by the control circuit 18 and are output in the test mode in a predetermined period. The first and second clock signals for test CLT and CLTB are not output in the normal mode. Therefore, the signal lines have a low potential (an L level) in the normal mode.

Specifically, in an odd stage of latch circuits 43, a first clock signal for test CLT is input to the input portions 43a and a second clock signal for test CLTB is input to the latch portions 43b.

However, in an even stage of latch circuits 43, the second clock signal for test CLTB is input to the input portions 43a and the first clock signal for test CLT is input to the latch portions 43b.

Therefore, when the first clock signal for test CLT is output, the input portions 43a of the odd stage of latch circuits 43 receive input signals. The latch portions 43b of the even stage of latch circuits 43 invert the output signals output from the input portions 43a, latch the inverted signals, and continue to output the latched signals. However, when the second clock signal for test CLTB is output, the input portions 43a of the even stage of latch circuits 43 receive input signals. The latch portions 43b of the odd stage of latch circuits 43 invert the output signals output from the input portions 43a, latch the inverted signals, and continue to output the latched signals.

The test signal DINT input to the initial stage of latch circuits 43 is sequentially shifted to the next stage of latch circuits 43 every half period of the first and second signals for test CLT and CLTB. Therefore, both the input terminal and the output terminal of only the latch circuit 43, to which the H level of test signal DINT is input, are transited to H levels by the test signal DINT.

The signal-generating circuit 42 includes signal output circuits 44 corresponding to the latch circuits 43. The signal output circuits 44 generate the control signals SGx1 to SGxm based on the input signals and the output signals of the corresponding latch circuits 43. The signal output circuits 44 include NAND circuits 44a to receive the input signals and the output signals of the latch circuits 43. When H level of signals (the test signals DLNT) are input, the NAND circuits 44a output low potential (L level) of output signals. The NAND circuits 44a are output to OR circuits 44c through inverter circuits 44b.

The OR circuits 44c are OR circuits with two input terminals. The other input terminals are connected to a mode selection line MDL through inverter circuits 44d. A test-enable signal ENBT is output from the control circuit 18 to the mode selection line MDL through an inverter circuit 45. The test-enable signal ENBT generated by the control circuit 18 has a low potential (the L level) in the test mode of testing the pixel circuits 20R, 20G, and 20B using the test device 22, and has an H level during normal operation (in the normal mode).

Therefore, the OR circuits 44c output a H level of output signals (the control signals SGx1 to SGxm) in the test mode (where the test-enable signal ENBT has the L level) when the L level of output signals are output from the NAND circuits 44a. Further, in the test mode, when the H level of output signals are output from the NAND circuits 44a, the OR circuits 44c output the L level of output signals.

However, in the normal mode (where the test-enable signal ENBT has the H level), the OR circuits 44c output the L level of output signals regardless of the output signals from the NAND circuits 44a.

The OR circuits 44c are connected to the gates of each group of the corresponding test switches STR, STG, and STB through an even number (two in the present exemplary embodiment) of inverter circuits 44e and 44f. That is, the H level of output signals from the OR circuits 44c of the signal output circuits 44 as the control signals SGx1 to SGxm are output to the gates of each group of the corresponding test switches STR, STG, and STB.

Therefore, in the test mode, when the H level of test signal DINT is output, the control signals SGx1 to SGxm are sequentially output to the gates of the corresponding group of analog switches STR, STG, and STB through the latch circuits 43 that operate in response to the first and second clock signals for test CLT and CLTB.

The control circuit 18 controls the display panel 11 and the circuits 12 to 17. The control circuit 18 converts image data from the computer 23, which shows the display state of the display panel 11 and which is stored in the memory circuit 14, into matrix data showing the brightness gray scale levels of light emission of the organic EL elements 21. The matrix data includes scanning line driving signals to sequentially select a group of a row of pixel circuits and data line driving signals to determine the levels of the data voltages VRdata, VGdata, and VBdata to set the brightness of the organic EL elements 21 of the selected group of pixel circuits. The scanning line driving signals are supplied to the scanning line driving circuit 13. Further, the data line driving signals are supplied to the data line driving circuit 12.

Also, the control circuit 18 is in the test mode when the organic EL display 10 tests the pixel circuits 20R, 20G, and 20B of the display panel 11 using the test device 22. When the control circuit 18 is in the test mode, the control circuit 18 converts the image data for test from the test device 22, which is stored in the memory circuit 14, into the matrix data (the matrix data for test) that shows the brightness gray scale levels of the light emission of the organic EL elements 21.

The matrix data for test includes scanning line driving signals for test to sequentially select a group of pixel circuits of a row and data line driving signals for test to determine the levels of the data voltages for test VRdata, VGdata, and VBdata to determine the brightness for test of the organic EL elements 21 of the selected group of pixel circuits. The scanning line driving signals for test are supplied to the scanning line driving circuit 13. Further, the data line driving signals (video signals) for test are supplied to the data line driving circuit 12.

Moreover, in the test mode, the control circuit 18 outputs the test signal DINT, the first and second clock signals for test CLT and CLTB, and the test-enable signal ENBT at a predetermined timing.

The operation of the above-mentioned organic EL display 10 will now be described according to the operation of the pixel circuits 20.

The test mode that is an aspect of a driving method will now be described. The organic EL display 10 enters the test mode when it is connected to the test device 22. Specifically, the test according to the present exemplary embodiment is performed prior to the process for finally forming the organic EL elements 21 in a state where the display panel 11 and the circuits 12 to 18 are formed excluding the organic EL elements 21 in processes of manufacturing the organic EL display 10.

That is, an organic EL display which has been manufactured to a state where the organic EL elements 21 do not exist in the pixel circuits 20R, 20G, and 20B, that is, a state where the display panel 11 and the circuits 12 to 18 normally operate without light emission by the organic EL elements 21 is tested by the test device 22. Therefore, it is possible to avoid manufacturing useless organic EL elements 21 by performing a test that detects inferior goods because the test is performed before manufacturing the organic EL elements 21.

When the image data for test is output from the test device 22 to the organic EL display 10, the control circuit 18 is in the test mode and converts the image data for test into the matrix data (matrix data for test) that shows the brightness gray scale levels of the light emission of the organic EL elements 21.

First, the control circuit 18 outputs the precharge control signals PREINR, PREING, and PREINB and switches on the analog switches SPR, SPG, and SPB. The precharge voltages VDCPRER, VDCPREG, and VDCPREB of the precharge voltage-generating circuits 32 to 34 are supplied to the data lines for red, green, and blue DLR, DLG, and DLB of the corresponding data lines X1 to Xm, based on the on state of the analog switches SPR, SPG, and SPB. The data lines for red, green, and blue DLR, DLG, and DLB of the data lines X1 to Xm are precharged to the precharge voltages VDCPRER, VDCPREG, and VDCPREB.

Subsequently, the control circuit 18 terminates a precharge operation by extinguishing the precharge control signals PREINR, PREING, and PREINB and switching off the analog switches SPR, SPG, and SPB.

When the precharge operation is terminated, the control circuit 18 outputs the scanning line driving signals for test and the data line driving signals for test (video signals) to the scanning line driving circuit 13 and the data line driving circuit 12.

When the scanning line Yn is selected by the scanning line driving circuit 13, the transistor for program Q2 of each group of pixel circuits 20R, 20G, and 20B on the scanning line Yn is switched on.

Concurrently with this, the data line driving circuit 12 receives the video signals from the control circuit 18 and sequentially supplies the data voltages VRdata, VGdata, and VBdata to the data lines for red, green, and blue DLR, DLG, and DLB of the data lines X1 to Xm. Therefore, the data voltages VRdata, VGdata, and VBdata with levels corresponding to the brightness gray scale levels are sequentially supplied to the pixel circuits 20R, 20G, and 20B on one selected scanning line. That is, the data voltages VRdata, VGdata, and VBdata are sequentially supplied to the group of pixel circuits for red, green, and blue 20R, 20G, and 20B connected on the selected scanning line in the column direction thereof.

After a predetermined time has lapsed since the data voltages VRdata, VGdata, and VBdata are sequentially supplied in the column direction, the test circuit 17 is activated. That is, the control circuit 18 outputs the one-pulse test signal DINT and the first and second clock signals for test CLT and CLTB to the test circuit 17. Furthermore, the control circuit 18 outputs the L level of test-enable signal ENBT to the test circuit 17.

As a result, the control signals SGx1 to SGxm are sequentially output for each group of test switches STR, STG, and STB provided in the data lines for red, green, and blue DLR, DLG, and DLB of the data lines X1 to Xm in response to the first and second clock signals for test CLT and CLTB.

The test switches STR, STG, and STB connect the data lines for red, green, and blue DLR, DLG, and DLB of the pixel circuits 20R, 20G, and 20B, in which the data voltages VRdata, VGdata, and VBdata are sequentially written, to the corresponding test lines for red, green, and blue TLR, TLG, and TLB. As a result, the voltages of the data lines for red, green, and blue DLR, DLG, and DLB based on the data voltages VRdata, VGdata, and VBdata supplied to the data lines for red, green, and blue DLR, DLG, and DLB of the data lines X1 to Xm are sequentially read from the test lines for red, green, and blue TLR, TLG, TLB as detection signals Vmr, Vmg, and Vmb. The detection signals Vmr, Vmg, and Vmb read from the test lines for red, green, and blue TLR, TLG, and TLB are output to the test device 22.

The test device 22 tests the characteristics of the pixel circuits 20R, 20G, and 20B based on the detection signals Vmr, Vmg, and Vmb. That is, the test device 22 can test the characteristics of the pixel circuits 20R, 20G, and 20B based on the actual operation of precharging the data lines and writing the data voltages VRdata, VGdata, and VBdata in the data lines.

In cases where the test result does not exist within a reference range, the test device 22 makes a determination to proceed to the next manufacturing process when it is determined that the organic EL display 10 is an inferior goods.

The characteristics of the above-mentioned organic EL display 10 will now be described.

(1) According to the present exemplary embodiment, the test circuit 17 is provided in the organic EL display 10 including the precharge circuit 16. The test circuit 17 performs normal operations of precharging the data lines X1 to Xm and then writing the data voltages VRdata, VGdata, and VBdata in the data lines X1 to Xm and outputs the voltages (the detection signals Vmr, Vmg, and Vmb) of the data lines, in which the data voltages VRdata, VGdata, and VBdata are written. Therefore, the output voltages as detection signals are output to the test device 22. The test device 22 can test whether a sufficient amount of data has been written in the pixel circuits, including the data lines, with a high degree of precision.

(2) According to the present exemplary embodiment, it is possible to perform the test highly precisely with a very simple circuit structure because it is possible to output the detection signals Vmr, Vmg, and Vmb of the data voltages VRdata, VGdata, and VBdata written in the data lines only by providing the signal-generating circuit 42 that include the shift registers in the test device 22 and switching on the test switches STR, STG, and STB connected to the data lines X1 to Xm by the signal-generating circuit 42.

(3) In the present exemplary embodiment, each of the data lines X1 to Xm includes the data lines for red, green, and blue DLR, DLG, and DLB. In the test circuit 17, the test lines for red, green, and blue TLR, TLG, and TLB are provided in the data lines for red, green, and blue DLR, DLG, and DLB, respectively. The voltages (the detection signals Vmr, Vmg, and Vmb) of the data voltages VRdata, VGdata, and VBdata written in the corresponding data lines for red, green, and blue DLR, DLG, and DLB are detected using the test lines for red, green, and blue TLR, TLG, and TLB.

Therefore, because the light emitting colors of the organic EL elements 21 are different from each other, it is possible to test the pixel circuits 20R, 20G, and 20B with different operation states, such as the precharge voltages VDCPRER, VDCPREG, and VDCPREB with a high degree of precision.

(4) In the present exemplary embodiment, the test is performed prior to the process of finally manufacturing the organic EL elements 21 in the state where the display panel 11 and the circuits 12 to 18 are formed excluding the organic EL elements 21.

Therefore, because it is determined whether the pixel circuits 20R, 20G, and 20B are defective before the organic EL elements 21 are manufactured, it is possible to avoid manufacturing useless organic EL elements 21 when the test result does not exist within the reference range.

(5) In the present exemplary embodiment, the test circuit 17 sequentially selects the data lines X1 to Xm, each including the data lines for red, green, and blue DLR, DLG, and DLB every half period of the first and second clock signals for test CLT and CLTB. After the data voltages VRdata, VGdta, and VBdata are sequentially written in the data lines X1 to Xm each including the data lines for red, green, and blue DLR, DLG, and DLB, the voltages of the data lines X1 to Xm each including the data lines for red, green, and blue DLR, DLG, and DLB, in which the data voltages VRdata, VGdata, and VBdata are written, are sequentially written in the data lines X1 to Xm. As a result, it is possible to reduce the amount of time for performing the test.

(6) In the present exemplary embodiment, the output circuits 44 of the signal-generating circuit 42 use one control signal SGx1 to SGxm for the data lines for red, green, and blue DLR, DLG, and DLB that form the data lines X1 to Xm and output the voltages of the data lines for red, green, and blue DLR, DLG, and DLB to the corresponding test lines for red, green, and blue TLR, TLG, and TLB. Therefore, it is possible to simplify circuit structures.

Second Exemplary Embodiment

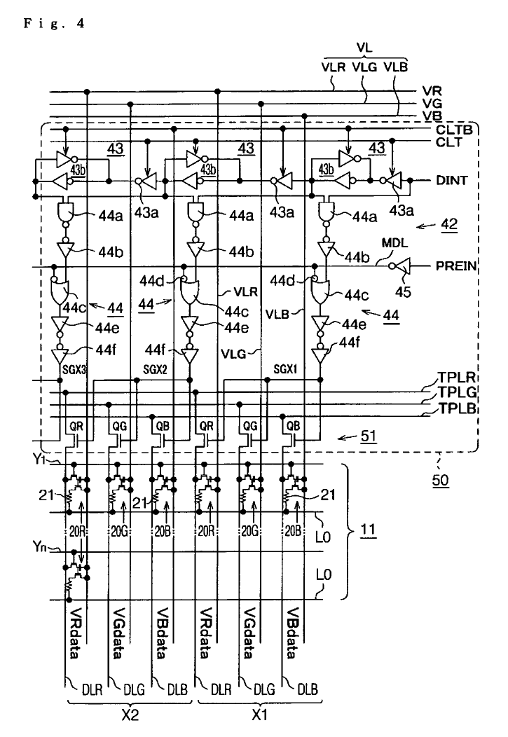

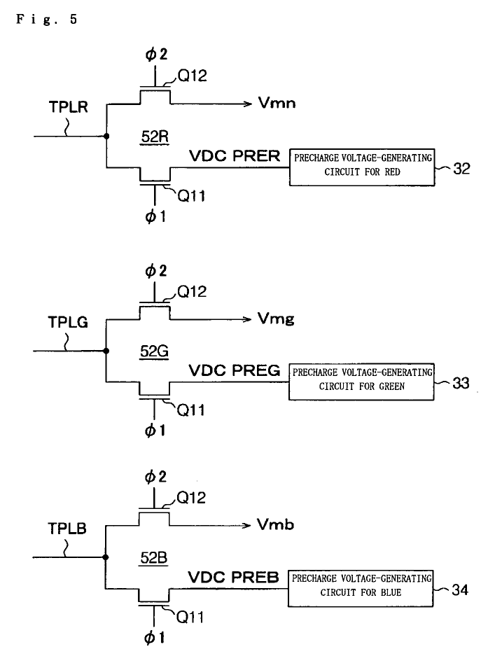

A second exemplary embodiment of the present invention will now be described with reference to FIGS. 4 and 5. The present exemplary embodiment has characteristics in that it shares the test lines for red, green, and blue TLR, TLG, and TLB and the precharge power lines for red, green, and blue PRELR, PRELG, and PRELB, which have been described in the first exemplary embodiment. Therefore, only the characteristic parts will now be described for convenience of the description.

In FIG. 4, a gate circuit 51, used as both the first gate circuit 31 and the second gate circuit 41, which have been described in the first exemplary embodiment, is provided in a precharge and test circuit 50.

The gate circuit 51 includes analog switches QR, QG, and QB having N channel FETs connected to the data lines for red, green, and blue DLR, DLG, and DLB of the data lines X1 to Xm. That is, in the present exemplary embodiment, a group of analog switches QR, QG, and QB are provided in each group of pixel circuits for red, green, and blue 20R, 20G, and 20B connected in the row direction, that is, on a selected scanning line.

Sources of the analog switches for red (hereinafter, referred to as switches for red) QR are connected to a test and precharge line for red TPLR as an input and output signal line and drains thereof are connected to the corresponding data lines for red DLR. Sources of the analog switches for green (hereinafter, referred to as switches for green) QG are connected to a test and precharge line for green TPLG as an input and output signal line and drains thereof are connected to the data lines for green DLG. Sources of the analog switches for blue (hereinafter, referred to as switches for blue) QB are connected to a test and precharge line for blue TPLB as an input and output signal line and drains thereof are connected to the data lines for blue DLB.

The on and off states of the analog switches for red, green, and blue QR, QG, and QB are controlled based on the control signals SGx1 to SGxm from a signalgenerating circuit 53. The structure of the signal-generating circuit 53 according to the present exemplary embodiment is different from that of the signal-generating circuit 42 according to the first exemplary embodiment only in that a test and precharge enable signal PREIN is used instead of the test-enable signal ENBT. Therefore, for convenience of the description, the same reference numerals as those of the first exemplary embodiment are given to the respective circuit elements and a detailed description thereof will be omitted.

In the normal mode, the test signal DINT is output and the first and second clock signals for test CLT and CLTB are not output. The test signal DINT has the L level. The test and precharge enable signal PREIN is transited from the L level to the H level when it is time for performing a precharge operation. When the precharge operation is completed, the test and precharge enable signal PREIN is transited from the H level to the L level. Therefore, in the normal mode, all of the control signals SGx1 to SGxm corresponding to the data lines X1 to Xm have the H level. Thus, all of the data lines X1 to Xm are precharged at once because all of the analog switches for red, green, and blue QR, QG, and QB are switched on.

On the other hand, in the test mode, the test and precharge enable signal PREIN has the L level. The one-pulse test signal DINT is output. Therefore, the control signals SGx1 to SGxm are generated in synchronization with the first and second clock signals for test CLT and CLTB as in the first exemplary embodiment. The analog switches for red, green, and blue QR, QG, and QB are switched on in response to the control signals SGx1 to SGxm. Thereby, the voltages based on the precharge voltages VDCPRER, VDCPREG, and VDCPREB are output from the data lines for red, green, and blue DLR, DLG, and DLB of the data lines X1 to Xm to test and precharge lines for red, green, and blue TPLR, TPLG, and TPLB.

One end of each of the test and precharge lines for red, green, and blue TPLR, TPLG, and TPLB is connected to each of switching circuits 52R, 52G, and 52B. As illustrated in FIG. 5, each of the switching circuits 52R, 52G, and 52B include a first gate transistor Q11 and a second gate transistor Q12. The first gate transistor Q11 and the second gate transistor Q12 according to the present exemplary embodiment constitute a third switch.

The first gate transistor Q11 of the switching circuit 52R is switched on based on a first gate signal φ1. As the first gate transistor Q11 is switched on, the precharge voltages VDCPRER, VDCPREG, and VDCPREB from the precharge voltage-generating circuits for red, green, and blue 32 to 34 are supplied to the corresponding test and precharge lines for red, green, and blue TPLR, TPLG, and TPLB. In the present exemplary embodiment, the first gate signal φ1 is output from the control circuit 18. The H level of first gate signal φ1 is output only at the time of precharge in the normal mode and the test mode.

On the other hand, the second gate transistor Q12 of the switching circuit 52R is switched on based on a second gate signal φ2. As the second gate transistor Q12 is switched on, the voltages of the data lines for red, green, and blue DLR, DLG, and DLB received through the corresponding test and precharge lines for red, green, and blue TPLR, TPLG, and TPLB are output to the test device 22 (not shown). In the present exemplary embodiment, the second gate signal φ2 is output from the control circuit 18. The H level of second gate signal φ2 is output while the control signals SGx1 to SGxm are output in the test mode.

According to the present exemplary embodiment, the test and precharge lines for red, green, and blue TPLR, TPLG, and TPLB are provided. The test lines for red, green, and blue TLR, TLG, and TLB and the precharge power lines for red, green, and blue PRELR, PRELG, and PRELB described in the first exemplary embodiment are shared by the test and precharge lines TPLR, TPLG, and TPLB. According to the present exemplary embodiment, the gate circuit 51 is also provided. The first gate circuit 31 and the second gate circuit 41 described in the first exemplary embodiment are shared by the gate circuit 51.

Therefore, according to the present exemplary embodiment, it is possible to reduce the size of the circuits in addition to the effects (1) to (6) according to the first exemplary embodiment.

Third Exemplary Embodiment

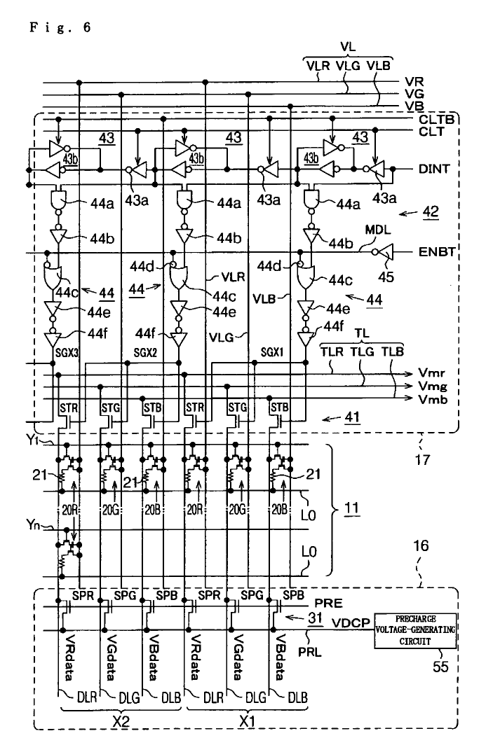

A third exemplary embodiment of the present invention will now be described with reference to FIG. 6.

In the first exemplary embodiment, the precharge power lines for red, green, and blue PRELR, PRELG, and PRELB corresponding to the data lines for red, green, and blue DLR, DLG, and DLB are provided. On the contrary, the present exemplary embodiment has characteristics in that the same precharge voltages are supplied to the data lines for red, green, and blue DLR, DLG, and DLB. Therefore, for convenience of the description, only the characteristic part will now be described.

FIG. 6 is a circuit schematic illustrating internal circuit structures of pixel circuits and precharge circuits according to the present exemplary embodiment. In FIG. 6, a precharge power line PRL as a precharge signal supply line is provided in a precharge circuit 16 according to the present exemplary embodiment for the data lines for red, green, and blue DLR, DLG, and DLB of the data lines X1 to Xm. Therefore, the precharge power line PRL is connected to the data lines for red, green, and blue DLR, DLG, and DLB of the data lines X1 to Xm through the analog switches SPR, SPG, and SPB of the first gate circuit 31. Further, the precharge power line PRL is connected to a precharge voltage-generating circuit 55. A precharge voltage VDCp is supplied from the precharge voltage-generating circuit 55.

The analog switches SPR, SPG, and SPB of the first gate circuit 31 are adapted to receive a common precharge control signal PRE from the control circuit 18. Therefore, when the precharge control signal PRE is output from the control circuit 18 to the analog switches SPR, SPG, and SPB, the precharge voltage VDCp is simultaneously supplied to the data lines for red, green, and blue DLR, DLG, and DLB of the data lines X1 to Xm.

According to the present exemplary embodiment, the precharge voltage VDCp of the precharge voltage-generating circuit 55 is supplied to the data lines for red, green, and blue DLR, DLG, and DLB of the data lines X1 to Xm by one precharge power line PRL. Therefore, it is possible to reduce the number of wiring lines compared with the first exemplary embodiment. As a result, according to the present exemplary embodiment, it is possible to reduce the size of the circuits in addition to the effects (1), (2), and (4) to (6), compared to the first exemplary embodiment.

Fourth Exemplary Embodiment

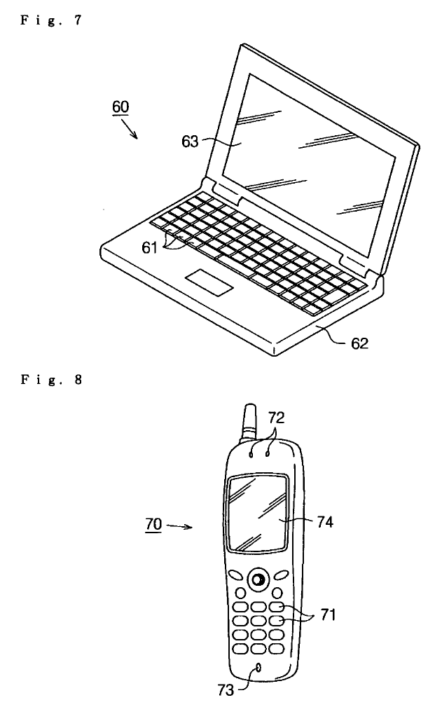

Application of the organic EL display 10 as the electro-optical device described in the first to third exemplary embodiments to electronic apparatuses, will now be described with reference to FIGS. 7 and 8. The organic EL display 10 can be applied to various electronic apparatuses, such as a mobile personal computer, a mobile telephone, and a digital camera.

FIG. 7 is a perspective view illustrating a structure of a mobile personal computer. In FIG. 7, a personal computer 60 includes a keyboard 61, a main body 62, and a display unit 63 using the organic EL display 10. In this case, the display unit 63 using the organic EL display has the effects similar to those of the above exemplary embodiments. As a result, the personal computer 60 can display images with small defects.

FIG. 8 is a perspective view illustrating a structure of a mobile telephone. In FIG. 8, a mobile telephone 70 includes a plurality of manipulation buttons 71, an earpiece 72, a mouthpiece 73, and a display unit 74 using the organic EL display 10. In this case, the display unit 74 using the organic EL display 10 has the effects similar to those of the above exemplary embodiments. As a result, the mobile telephone 70 can display image with small defects.

Further the embodiments according to the present invention may be changed as follows.

In the above exemplary embodiments, the test is performed prior to the process of manufacturing the organic EL elements 21 in the state where the display panel 11 and the circuits 12 to 18 are formed excluding the organic EL elements 21. The test may be performed after manufacturing the organic EL elements 21.

In the above exemplary embodiments, the voltages of the data lines X1 to Xm, in which the data voltages VRdata, VGdata, and VBdata are written, are output after performing the common operations of precharging the data lines X1 to Xm and writing the data voltages VRdata, VGdata, and VB data.

Other tests such as a test of the wiring line capacitance of the data lines X1 to Xm, may be performed by outputting the voltages of the data lines based on the precharge voltage after precharging the data lines X1 to Xm without writing the data voltages VRdata, VGdata, and VBdata in the data lines X1 to Xm.

According to the above exemplary embodiments, the precharge voltages VDCPRER, VDCPREG, and BDCPREB are changed in accordance with the electric characteristics of the organic EL elements 21 for the respective colors. However, for example, when the electric characteristics of the organic EL elements for red and green are the same, the precharge voltages may be the same. In such a case, it is possible to reduce the number of precharge power lines and the number of precharge voltage-generating circuits.

According to the above exemplary embodiments, appropriate effects are obtained by implementing the pixel circuits 20 as electronic circuits. However, electronic circuits that drive current driving elements, such as light-emitting elements, for example, light emission diodes (LED) or field emission diodes (FED) other than the organic EL elements 21 may be used.

According to the above exemplary embodiments, the current driving elements of the pixel circuits 20R, 20G, and 20B are implemented as organic EL elements 21; however, they may be implemented as inorganic EL elements. That is, an inorganic EL display formed of the inorganic EL elements may be used.

The pixel circuits 20R,20G, and 20B according to the above exemplary embodiments are implemented as voltage driving pixel circuits; however, they may be applied to the organic EL display of current driving pixel circuits. The pixel circuits 20R, 20G, and 20B may be applied to the organic EL display of digitally driven pixel circuits, such as time division, and an area gray scale.

According to the above exemplary embodiments, an organic EL display including the pixel circuits 20R, 20G, and 20B for the respective colors for the three organic EL elements 21, is used. However, an organic EL display formed of the pixel circuits of the organic EL element for one color may be used.

What is claimed is:

1. An electro-optical device, comprising:
a plurality of scanning lines;
a plurality of data lines;
a plurality of electro-optical elements provided to correspond to intersections of the plurality of scanning lines and the plurality of data lines;
first switches to control the supply of a precharge signal from a precharge signal supply line connected to at least one data line of the plurality of data lines to the at least one data line;
second switches connected to the at least one data line of the plurality of data lines to control the output of a detection signal from the at least one data line to test lines; and
a data line selection circuit to set the on or off state of the second switches.

2. An electro-optical device, comprising:
a plurality of scanning lines;
a plurality of data lines;
a plurality of electro-optical elements provided to correspond to intersections of the plurality of scanning lines and the plurality of data lines;
third switches to control the supply of precharge signals from input and output signal lines connected to at least one data line of the plurality of data lines to the at least one data line and to control the output of a test signal from the at least one data line to the input and output signal lines; and
a data line selection circuit to set the on or off state of the third switches.

3. An electro-optical device, comprising:
a plurality of scanning lines;
a plurality of data lines;
a plurality of electro-optical elements provided to correspond to intersections of the plurality of scanning lines and the plurality of data lines;
at least two precharge lines to supply precharge signals to at least two data lines of the plurality of data lines;
first switches to control the output of the precharge signals from the at least two precharge lines to the at least two data lines; and
second switches to control the output of detection signals from the at least two data lines of the plurality of data lines to test lines.

4. An electro-optical device according to claim 3, further comprising:
a data line selection circuit to control precharge signals output from the at least two data lines to the test lines by sequentially operating the second switches.

5. A method of driving an electro-optical device, including:
a plurality of scanning lines;
a plurality of data lines wired to intersect the scanning lines;
electronic circuits provided to correspond to intersections of the scanning lines and the data lines; first switches to control the supply of a precharge signal from a precharge signal supply line connected to at least one data line of the plurality of data lines to the at least one data line; and
second switches connected to the at least one data line of the plurality of data lines to control the output of a detection signal from the at least one data line to test lines, the method comprising:
supplying a precharge signal from a precharge signal supply line to the data lines through the first switches when one of the plurality of scanning lines is selected;
supplying data signals to electronic circuits connected to the selected scanning line through the data lines; and
outputting data signals supplied to the data lines as detection signals to test lines through the second switches.

6. A method of driving an electro-optical device, including:
a plurality of scanning lines;
a plurality of data lines wired to intersect the scanning lines;
electronic circuits provided to correspond to intersections of the scanning lines and the data lines;
at least two precharge lines to supply precharge signals to at least two data lines of the plurality of data lines;
first switches to control the output of the precharge signals from the at least two precharge lines to the at least two data lines; and
second switches to control the output of detection signals from the at least two data lines of the plurality of data lines to test lines,
the method comprising:
supplying a precharge signal from a precharge signal supply line to the data lines through the first switches when one of the plurality of scanning lines is selected;
supplying data signals to electronic circuits connected to the selected scanning line through the data lines; and
outputting data signals supplied to the data lines as detection signals to the test lines through the second switches.

7. An electronic apparatus equipped with the electro-optical device according to claim 1.
